(19) United States
(12) Patent Application Publication
(10) Pub. No.: US 2009/0094656 A1
(43) Pub. Date: Apr. 9, 2009

(54) System, method, and apparatus for connecting non-co-located video content viewers in virtual TV rooms for a shared participatory viewing experience

(76) Inventor: John B. Carlucci, Boulder, CO (US)

Correspondence Address: John B. Carlocci, 2441 5th St., Boulder, CO, 80304, US

(21) Appl. No.: 12/286,770

(22) Filed: Oct. 2, 2008

Related U.S. Application Data
(60) Provisional application No. 60/977,114, filed on Oct. 3, 2007.

(51) Int. Cl. H04N 7/173

(52) U.S. Cl. 725/115

(57) ABSTRACT

System, method and apparatus for connecting non-co-located video content viewers in Virtual TV Rooms for a shared participatory viewing experience. A multi-platform communication system allows viewers to connect across a plurality of video content delivery services in self-organized viewing communities to interact with each other as they enjoy the content as if they were in the same physical viewing location. A mechanism is provided to allow users to quickly see what their friends are currently watching and join them. In addition to exchanging text-based messages, viewers also share their impressions of the current video program via a defined set of single-key-click impressions called Buzz Tags™. A database and calculation process aggregates this information in to Buzz Profiles as a resource for users to find interesting content and fellow viewers with similar interests.

### CROSS-REFERENCE TO RELATED APPLICATIONS

This Non-Provisional Application claims priority to U.S. Provisional Patent Application No. 60/977,114, filed Oct. 3, 2007, which is incorporated herein by reference in its entirety.

### FIELD OF THE INVENTION

The present invention relates to video content distribution systems, social networking and information systems accessed over a distributed network, and more particularly to a cross-platform-based system for connecting non-co-located viewers in a shared participatory viewing experience.

### BACKGROUND OF THE INVENTION

The average American spends nearly a quarter of their waking hours or 4 hours per day watching television. To date, television viewing has primarily been a non-participatory experience enjoyed either individually or shared with co-located family members or visiting friends. As the rapid growth and participation in on-line social networks has recently demonstrated, there is a natural desire on the part of individuals to share their day-to-day experiences with their community of friends. Unfortunately it is often impractical to gather these geographically disperse communities of friends together in a single physical location to enjoy a shared viewing experience. What is needed is a mechanism to connect non-co-located viewers together in self-forming communities to enjoy a shared participatory viewing experience.

Providing such a mechanism is complicated by the fact that individual viewers will likely have different means of receiving their television programming. Some community members may receive their content via terrestrial over-the-air means while others receive the content via cable television or satellite systems. Still others may receive their content via streaming media over the Internet. Viewing communities, however, are based on social networks and not on video service provider networks. Additional complexity results from the fact that viewers may not all be receiving the programming at the same time. Community members may be located in different time zones and/or may be using various time-shifting apparatus (ex. DVR). What is needed is a mechanism that will operate across all means of television content delivery and accommodate disparate viewing times.

Another important consideration is the disparate platforms individual viewers use to view their television programming and to interact with their social network. In addition to the video delivery platforms cited above, individuals are using a plurality of digital communication platforms for social networking including personal computers, cell phones and other mobile devices. In some cases, the video delivery platform may be the same as the social networking platform but this cannot be assured and generally is not the case. For example, a user may be enjoying video content on a cable television platform while social networking on a PC platform. What is needed is a mechanism that will interoperate across all commonly used video content delivery and social networking platforms.

### BRIEF DESCRIPTION OF THE INVENTION

The present invention provides a system for connecting non-co-located viewers in a shared participatory viewing experience through the use of Virtual TV Rooms. The system operates across a plurality of video content delivery services such as terrestrial over-the-air, cable television, satellite and Internet streaming allowing viewers to participate irrespective of their video content delivery network. Further, the invention allows viewers to connect using a plurality of video delivery and digital communication platforms including set-top-boxes, internet enabled viewing monitors, personal computers, cell phones and other mobile devices.

Viewers assemble in self-organized social communities within a plurality of application specific Virtual TV Rooms to share viewing events and interact with each other as if they were in the same physical room. An invitation mechanism allows users to invite friends to join the system as well as join them in future scheduled viewing events. In addition to providing basic interaction between members of the Viewing Community, Virtual TV Rooms may also provide application specific metadata related to the viewing event. For example, a Sports specific Virtual TV Room may provide game or team statistics for the event currently being viewed as well as the current standings of the fantasy football league to which the community members belong.

Viewers interact with each other in the Virtual TV Room via text messages and one-click impressions known as Buzz Tags™. Buzz Tags™ can be sent at any time and represent the viewer's impression of the content currently being viewed. In addition to signaling the viewer's impression to the other community members in the Virtual TV Room, Buzz Tags™ along with their associated program and time index are stored in a database. A calculation process has the ability to aggregate Buzz Tags™ across users, communities and programs to create a Buzz Profile. This profile can then be used to help users find interesting content. For example, a user can view a Buzz Profile aggregated across their friends for a specific television program or series to determine whether it is worth watching. Further, Buzz Profiles may be used to help a user find other viewers interested in similar programs. Finally, Buzz Tags™ can also be used to help select advertising content appropriate for the current video program and provide a mechanism for feedback on viewer impressions of the Ad.

A mechanism is provided to allow users to quickly find friends from their community currently using the system and join them. Current viewing information consisting of the program an active user is watching along with his/her most recent Buzz Tag™ and text impression is accessible to the user's community of friends. This current viewing information may be accessed via a plurality of video and digital communication platforms. A friend viewing the user's current information may then send a request to join the user in his/her Virtual TV Room. In one example of operation, a first user might access the graphical user interface on a social networking site to view a list of viewing information for each friend currently using the system. As she discovers multiple friends viewing the same program, she can click a button to send a request to join the viewing session. A second user already in the Virtual TV Room may then acknowledge the request and invite her in.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

FIG. 1 is a drawing for explaining the configuration of the Community TV System in accordance with the principals of the present invention.

FIG. 2 is a flowchart for explaining Buzz Tag™ and rating entry and Buzz Profile generation by the system in accordance with the principals of the present invention.

FIG. 3 is a flowchart for explaining search using Buzz Profile and keywords by the system in accordance with the principals of the current invention.

FIG. 4 is a diagram that is illustrative of a search display screen in accordance with the principals of the present invention.

FIG. 5 is a diagram that is illustrative of a remote control for entering Buzz Tags™ in accordance with the principals of the present invention.

FIG. 6 is a flowchart for explaining cataloging of Advertisement assets for later retrieval by the system in accordance with the principals of the invention.

FIG. 7 is a flowchart for explaining retrieval of catalogued Advertisement assets by the system in accordance with the principals of the invention.

### DETAILED DESCRIPTION

Embodiments of the present invention are described herein in the context of a system, method, and apparatus for connecting non-co-located video content viewers in Virtual TV Rooms for a shared participatory viewing experience. Those of ordinary skill in the art will realize that the following detailed description of the present invention is illustrative only and is not intended to be in any way limiting. Other embodiments of the present invention will readily suggest themselves to such skilled persons having the benefit of this disclosure.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

In accordance with the present invention, the components, process steps, and/or data structures may be implemented using various types of operating systems, computing platforms, computer programs, and/or general purpose machines without departing from the scope and spirit of the inventive concepts disclosed herein.

### DEFINITIONS

Viewing Community—A self-organized group of viewers who regularly connect to share their viewing experience.

Virtual TV Room—A conceptual gathering place where a community of viewers connect to share their viewing experience.

Community TV System—An arrangement of distributed components used to realize a Virtual TV Room.

Buzz Tags™—Single-key-click shorthand viewing impressions sent by individual users to signal how they feel about the content they are currently viewing.

Buzz Profile—An aggregation of Buzz Tags™ from a selectable group of users used to characterize a video program for searches and recommendations.

Demographic ID—Numeric identifier for a specific demographic group.

Asset ID—Unique Numeric identifier for the content & metadata comprising an advertisement.

Video Content ID—Unique Numeric identifier for a specific piece of video content and associated information.

User ID—Unique Numeric identifier associated with an individual Virtual TV Room user.

### Descriptions

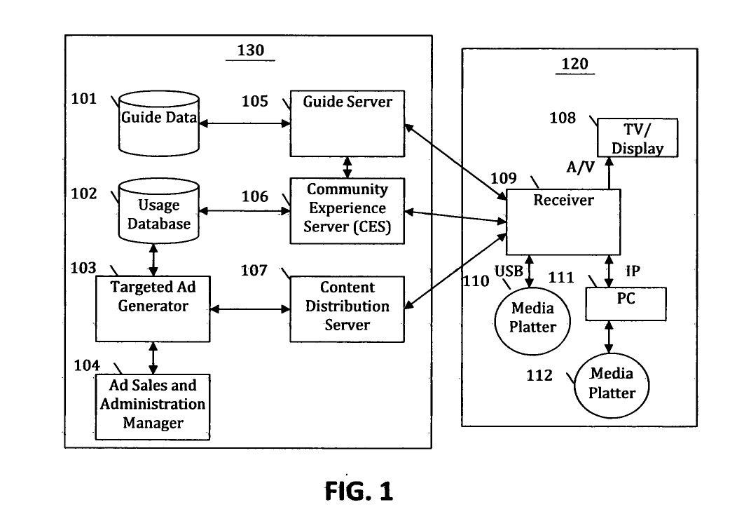

First, referring to FIG. 1, the configuration of a system for creating a Virtual TV Room with the first embodiment to which the present invention is applied will be described.

The Virtual TV Room system involves equipment located with a plurality of viewers 120 and server equipment 130 located remote from the viewer connected via a network such as or a combination of the internet, cable network, public telephone, fiber-to-the-home, wireless network and the like.

The viewer equipment consists of a receiver device 109, for example a TV, Digital STB, Personal Computer, mobile phone. The receiver is capable of receiving and transmitted messages across the network to the server equipment 130.

The receiver includes memory and CPU, and is connected to or incorporated into a display device 108 such as a television or integrated display panel. The display device may be capable of simultaneously displaying graphics associated with the viewer input and communication messages as well as video. Alternately, separate display devices may be used for the video viewing and the message generation and reception.

A user input panel or keypad (not shown) may be used by the viewer to interact with receiver device. Optional storage media 109 may be incorporated into the receiver for the purpose of recording video for DVR type functionality.

A personal computer 111 may communicate to the receiver for the purpose of control or media exchange via a local area network such as an IP network. The personal computer can also make use of storage media 110 for video buffering and DVR type functionality.

The server equipment 130 is operated by a business operator who provides a service delivering the Virtual TV Room service to viewers. A network provides connection to the viewer located equipment 120.

The community experience server 106 (CES) is the relay station for viewer-generated input signaled from the viewer location. Each receiver 109 establishes a session with the CES 106 for participation in the Virtual TV Room. The CES 106 communicates in real-time with the receivers via a set of suitable messaging protocols such as XMPP, SIP, or HTTP. The CES 106 may manage invitations allowing users to invite community members to join the system, as well, as, join them in current and future scheduled Virtual TV Room viewing events. In addition to providing basic interaction between members of the Viewing Community, the CES may also provide Virtual TV Rooms with application specific metadata related to the viewing event. For example, the receiver 109 may receive game or team statistics from the CES 106 for the event currently being viewed as well as the current standings of the fantasy football league to which the viewer belongs as part of a Sports Clubhouse application specific Virtual TV Room.

The Guide Server 105 is a gateway of video content information such television program schedule information, video-on-demand metadata, and internet video asset information. A Guide Data repository 101 provides a database for storage of this information. This information may be sent to the viewer to ease content navigation, allows the viewer to easily identify the content they are watching, and signal this information via the Virtual TV Room system to associates. With video service description information, including for example zip code, video service provider, service type, provided during viewer registration, the Guide Server 105 identifies the set of video content information to deliver to each viewer.

The viewer transmits content identifying information provided by the Guide Server 105 along with viewer impression information such as Buzz Tags™, text and other viewer generated data such as commands. The CES 106 timestamps and stores the content identification and viewer impression information in the Usage Database 102.

For each viewer session, the CES 106 may generate a digest of the arriving Buzz Tags™ into a Buzz Profile for storage in the usage database. The stored information may be accessed by other elements of the system or by the CES 106 in the future. For instance, if a viewer is watching a time-shifted version of a program or an on-demand asset, associates' previously generated Buzz Tags™ and messages can be transmitted synchronized with the video content allowing the delayed viewing to share the experience of the prior audience.

The Content Distribution Servers 107 (CDS) delivers media assets such as advertisements to the receiver 109. When an advertisement placement opportunity arises, the CDS 107 requests an advertisement from the Targeted Ad Generator 103 (TAG).

The TAG may determine which advertisement to provide based on advertising campaign information from the Ad Sales and Administration Manager 104. The campaign information such as advertising contracts, rates and schedules may be used in conjunction with real-time and non-real-time targeting information. The targeting information may be based on for example historic Buzz Profile information, current Buzz Tag™, currently viewed program, historically viewed program, viewer associates, and/or current viewing group.

While the Virtual TV Room is described an independent system, it may be incorporated directly into a video delivery service such as satellite, cable, telcom or broadband or the like.

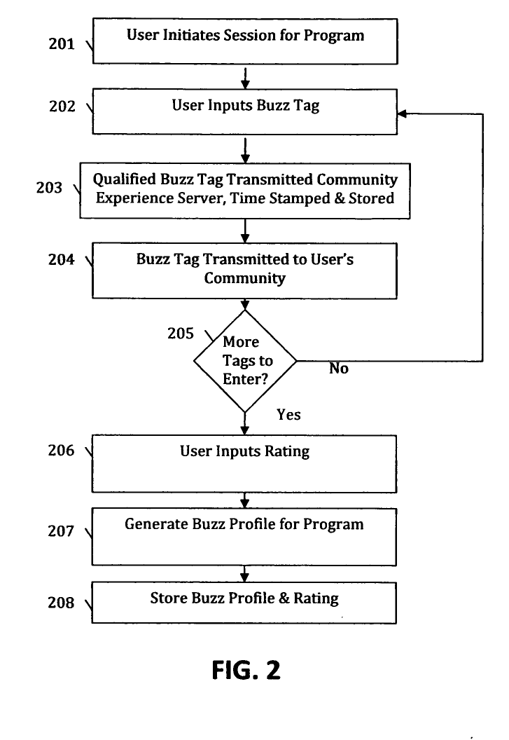

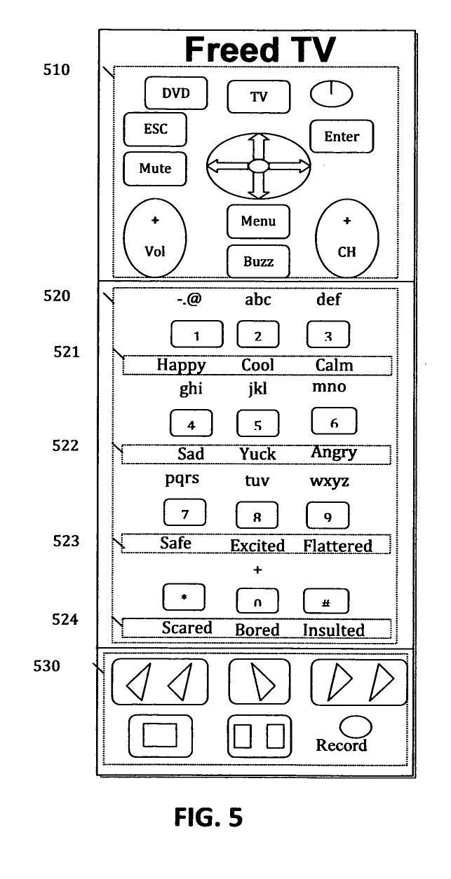

FIG. 2 is a flowchart depicting a routine for delivery of Buzz Tags™ and other information from a plurality of viewers to the system according to this embodiment. This routine is also discussed with reference to the system diagram FIG. 1. At step 201, the viewer instructs the receiver 119 to initiate a session with the CES 106 for example by prompting on the display or remote control such as the device illustrated on FIG. 5. The CES 106 receives a message from the receiver 119 indicating the program the viewer is watching and the community the viewer is interested in sharing the viewing experience with. These Viewing Communities can be private meaning participation is restricted by members or public meaning open to all participates within the system. For example, the receiver 119 may indicate they want to watch the program “Lost” with associates in the group “Friends”. The CES 106 identifies which associates within the group are currently connected to the system and informs of the new viewer connecting to the Virtual TV Room.

At Step 202, the viewer inputs Buzz Tags™, text, channel changes and other data via the display panel remote control or other input device associated with the receiver 109. The receiver 109 qualifies the input for example filtering the number of inputs per minute to reduce network traffic, fixing spelling errors or expanding message shorthand and transmits the information to the CES 106. At step 203, the CES 106 receives the message, timestamps and stores the information in the Usage Database 102 for later reference and play out. At step 204, the CES 106 reference the list of associates in the Virtual TV Room and transmits the updated information to their receivers 109.

If at step 205, the user still has channel changes, Buzz Tags™, text or other information to enter the viewer goes back to step 202 to enters information again. If the viewer is no longer entering information the receiver 109 carries the operation forward to step 206.

At step 206, the viewer, prompted by display 108 and using the input device, may enter an overall rating for the program that they completed viewing. The rating is transmitted by receiver 109 to the CES 106. At step 207, the CES 106 generates a digest from the Buzz Tags™ using a suitable normalization algorithm such as frequency or time-weighted average for each Buzz Tag™ parameter.

At step 207, the CES 106 stores the Buzz Profile along with the rating in the Usage Database 102.

An input device is incorporated in the present invention. In one embodiment, as shown in FIG. 5, a remote control device can be fashioned to ease the input of the Buzz Tags™. Television viewing is described as a laid-back experience in which the viewer is in a relaxed viewing posture. The single button entry ability of the example remote facilitates communication with other participants in the Virtual TV Room. The remote illustrated is similar to a traditional digital television receiver remote control. Menu navigation buttons 510 may allow the viewer to navigate on-screen menus and control channel change and volume. The recorded media controls 530, facilitate interaction with on demand, DVR and network DVR functions.

The numeric keypad section 520 service generic text and numeric entry functions. Text entry can be a part of the messages communicated to the CES 106. In addition, specific Buzz Tag™ T values may be associated with each button to facilitate tag entry, as shown by 521, 522, 523 and 524.

Operations on any of the keys, including navigation 510 and media control 530 may be used to generate commands sent to the CES 106 and distributes to receivers of the associates in the Virtual TV Room.

It should be noted that the remote control represents only one example of an input device that can be used in the system. Others may be incorporated for improved compatibility and harmony with the variety of receivers 109 incorporated in the system.

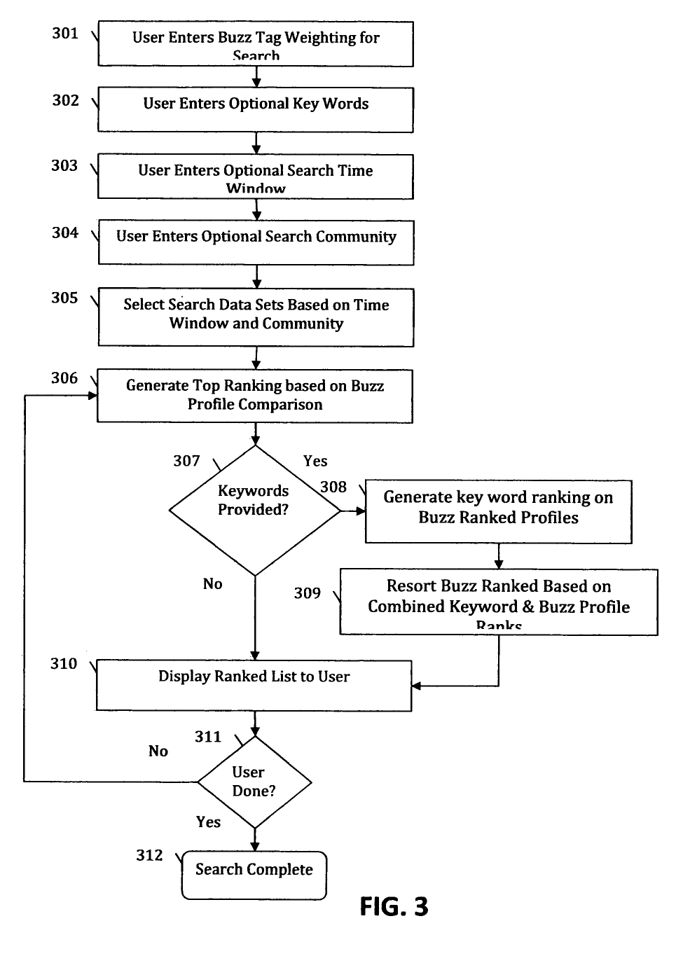

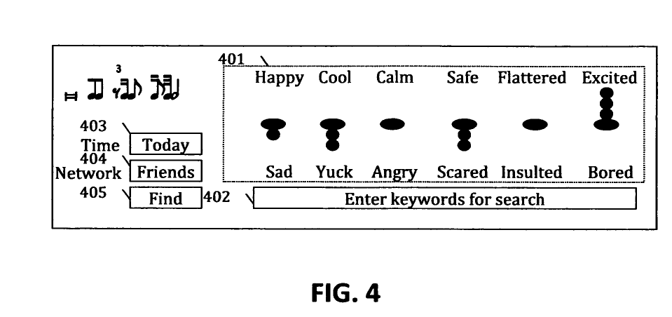

Referring to the flowchart in FIG. 3 and the illustration in FIG. 4 the search routine is described according to this embodiment. Searching large quantities of video content is difficult especially when the user is not clear on what they are looking for. Video content search facilitated by the Buzz Profile, viewer associates, text, rating, and video content information eases the task and provides the user with an enjoyable content navigation experience.

At step 301 the viewer interacts with an input screen 401 that allows them to manipulate the constituent parameters of the Buzz Profile. The user can manipulate the parameter value to match the profile of the content for which they are searching.

At step 302, the viewer may enter in optional search keywords for example using a text entry 402. At step 303 the user may chose to constrain the search based on a time window entered using a time window input controller such as 403. At step 304 the user may chose to constrain the search based on community by selecting a group of associates via the network selector 404. The chosen network may be all Virtual TV Room communities if the user wants a broad set of opinions. The user can also chose a network as small as a few friends that share a common perspective on media.

At step 305, the receiver 109 transmits to the CES 106 the parameters of the search to be performed. The CES 106 selects the data sets on the Usage Database server 107 to be searched based on provided constraints for example time and network.

At step 306, the CES 106, compares the input Buzz Profile with profile entries in data sets and generates a ranking for the top matches to the viewer request. Techniques may be used to speed the ranking process by pre-ordering the Buzz Profiles.

If at step 307, the user has specified keywords to be incorporated in the search, the routine continues to step 308 at which the CES 106 performs a keyword ranking on the top ranked Buzz Profile search items. The keyword search may be performed across any and all text elements associated with the Buzz Profile including video content information, rating, text and other command information. At step 309, the CES 106 may rank the top entries returned in the Buzz Profile ranking based on the keyword search rankings or the combined Buzz Profile and keyword rankings.

At step 310, the final list of top ranked items may be returned to the receiver 109 for display to the user.

If at step 311 the user is not satisfied with the search results after the initial top ranked list the may request subsequent ranked entries returning to step 306 by sending a follow on request from receiver 109 to CES 106. If the user is satisfied with the returned results the search completes at step 312 and the CES 106 may purge cached ranking results.

While the above example illustrated the search using the receiver 109 as the requesting entity, search request may be performed by other server entities as well. For example, another search service (not shown) may communicate with the CES 106 to perform a search requested by its client that it will aggregate with other search information for presentation.

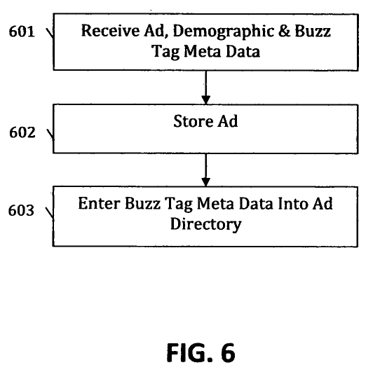

To effectively target advertising assets to viewers in the Virtual TV Room, the assets may be installed into the advertising asset directory structure. With reference to FIG. 6 and FIG. 1, at step 601, the TAG 103 receives from the Ad Sales and Administration Manager 104 the advertising asset along with targeting meta data and advertising campaign information describing business rules including ad delivery contract information. The targeting meta data may include information regarding programs, Buzz Tags™, historic viewing data, groups associations, historic Buzz Profiles, demographics and the like.

At Step 602, the TAG 103 stores the advertising asset on the Content Distribution Server 107. The Content Distribution Server 107 may generate an Asset ID to use for identifying the asset and performs other preparation for asset delivery such as distribution to distributed caches.

At step 603, the TAG 103 updates its asset directory information identifying what assets are associated with specific metadata that may include Buzz Tags™ and Buzz Profile.

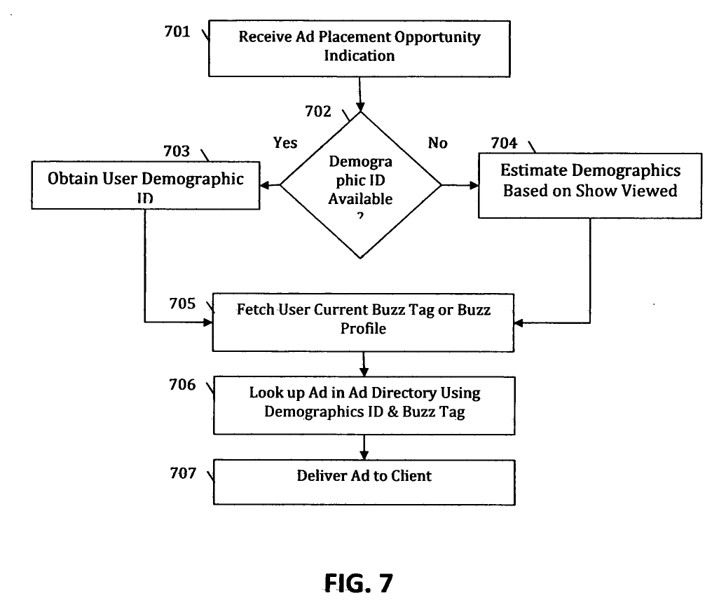

FIG. 7 in conjunction with FIG. 1 is used to explain placement of the catalogue advertisement. At step 701, the TAG 103 receives a message indicating an advertisement placement opportunity along with the Virtual TV Room context which may include program and channel along with associated viewers.

At step 702, if a Demographic ID is available the ID is fetched from the usage database 102. If no Demographic ID is available for the user operation continues to step 704.

At step 704, the Demographic ID of the viewer is estimated by the TAG 103 from the show they are viewing. This may be determined by accessing traditional viewing data for the program as collected by Nielsen or similar usage measurement service or by comparing to viewer to other system viewers with known demographics that view the same program and generated similar Buzz Profiles.

At step 705, the TAG 103 fetches targeting information for example the viewer's current Buzz Tag™ or Buzz Profile and Virtual TV Room association from the Usage Database 102. At step 706, the TAG 103 indexes into the Advertisement directory using the targeting to determine which ad should be delivered. The TAG 103 responds to the CDS 107 identifying the advertisement asset it should deliver. At step 706, the CDS 107 delivers the advertisement to the receiver 109 for display.

What is claimed is:

1. In a computer network including a central server and a plurality of client devices, a method for associating and connecting multiple viewers watching the same video program via a plurality of video content delivery networks wherein the viewers are not co-located in the same physical location, the method comprising the steps of: registering a first user along with his/her video service provider, service area & service tier in a central database; capturing the first user's current video program viewing information by direct text entry or cross referencing the user's current channel number to program guide data derived from registration information; publishing the first user's current program viewing information along with program impressions entered by the user to his/her established social network of friends; registered friends interested in sharing the viewing experience may then request to join the first user; upon approval from the first user, the users are connected via the server and share their viewing experience by exchanging impressions of the video program in real-time.

2. The method according to claim 1, wherein a registered user can send an invitation to other users to join him/her for a current or future viewing event.

3. The method according to claim 1 wherein a registered user can view the current video program and impressions of all members of their social network simultaneously.

4. The method according to claim 1, wherein metadata related to the video content and/or the community of connected users is used to enhance the interactive viewing experience.

5. The method according to claim 1, wherein public viewing sessions are available for any interested user to join.

6. The method according to claim 1, wherein viewers interact using a defined set of single key click viewing impressions referred to as Buzz Tags™.

7. The method according to claim 6, wherein the Buzz Tags™ impressions are captured in a database along with the User ID, Video Content ID, and index time within the video program.

8. The method according to claim 7, further comprising the step of aggregating the Buzz Tag™ impressions for a given Video Content ID to create a Buzz Profile.

9. The method according to claim 1, wherein viewers rate a given video program using a defined set of single key click viewer ratings.

10. The method according to claim 9, wherein the program rating is captured in a database along with the User ID and Video Content ID.

11. The method according to claim 1, further comprising the step of searching and recommending video programs based on the Buzz Profile and Rating of a user selected community of viewers for a given time window, program type and keyword match.

12. The method according to claim 1, further comprising the step of selecting advertising content based on demographic and Buzz Tag™ data.
